(19) United States
(12) Patent Application Publication
(10) Pub. No.: US 2003/0233465 A1
(43) Pub. Date: Dec. 18, 2003

(54) System and method for implementing communication middleware for mobile "Java" computing

(75) Inventors: Vui Le, Cypress, TX (US); Man Nguyen, Houston, TX (US); Tao Vu, Houston, TX (US)

Correspondence Address: HAYNES AND BOONE, LLP, 1000 LOUISIANA, SUITE 4300, HOUSTON, TX, 77002, US

(73) Assignee: Vuico, L.L.C., Houston, TX

(21) Appl. No.: 10/389,512

(22) Filed: Mar. 14, 2003

Related U.S. Application Data
(60) Provisional application No. 60/387,928, filed on Jun. 12, 2002.
(60) Provisional application No. 60/387,962, filed on Jun. 12, 2002.
(60) Provisional application No. 60/388,169, filed on Jun. 12, 2002.

(51) Int. Cl. G06F 15/16

(52) U.S. Cl. 709/231

(57) ABSTRACT

A method of implementing a client side remote method call from a Java-enabled mobile device includes executing an instruction at the mobile device to open a connection at a Host URL. The Host URL includes a server side object of the remote method call. An output stream is opened via the connection. Remote method call parameters are written to the server side remote method call object at the Host URL via the output stream. An input stream is opened via the connection for receiving return data from the Host URL. Lastly, the return data is queried for any occurrence of errors in the remote method call request in response the server side remote method call object and the remote method call parameters, wherein responsive to a detection of errors, remote method call error recovery process is executed for performing a restart of the remote method call in response to at least one recovery query prior to throwing a remote exception which terminates the remote method call.

This application claims the benefit of the earlier filed provisional applications Ser. No. 60/387,962, filed Jun. 12, 2002; Serial No. 60/387,928, filed Jun. 12, 2002; and Serial No. 60/388,169, filed Jun. 12, 2002, incorporated by reference herein in their entirety. Copending application, Attorney docket 32498.10, entitled “SYSTEM AND METHOD FOR IMPLEMENTING VIRTUAL MOBILE MESSAGING SERVICE” and assigned to the present assignee, filed concurrently herewith, is incorporated herein by reference in its entirety.

### BACKGROUND

The present disclosure relates generally to mobile communication systems, and more particularly to a system and method for implementing virtual mobile messaging services.

Cellular phones were initially developed for the purpose of voice telecommunications, however, recent technical innovations (wireless-communications technology, Internet technology, and especially hardware integration technology) have positioned it as an important information tool. For example, some of the newest cellular phone models have the capability of running Java applications. With such Java-enabled cell phones, diverse types of Java™ applications, like games (action, adventure, etc.), entertainment programs (karaoke), and business applications (stock information, online trading, etc.) are being developed and used. However, the hardware resources of such cellular phones are very limited.

In order to develop highly functional and useful applications capable of running on such mobile platforms and to compensate for the resource limitation, a close collaboration between the mobile devices and server side applications through a network is needed. A communications capability is vital for such mobile Java applications. Accordingly, communications is a key issue for improving the attractiveness of mobile Java applications on platforms that assume wireless connections.

Currently, there exist a number of forces acting in a kind of tug-of-war to shape the wireless market. Each of these forces is entrenched and unlikely to disappear soon. A first force includes demand for more advanced wireless services and applications that will enhance and improve people's lives at home and at work. A second force includes competing technology platforms and communication formats that are not interoperable and cause delays in rolling out truly useful new mobile applications and services.

Several issues in the wireless market are influenced by these forces and affect carriers, handset providers and enterprises both alike and in different ways. One issue involves a need for new services and revenue sources. Carriers are seeking service ideas and technology that can raise average revenue per unit (ARPU) from their enterprise customers. Such applications generally do not exist and are often difficult to deploy. Enterprises are seeking more effective ways to enhance employee productivity through more intelligent technology applications. Another issue includes a need to make more efficient use of available bandwidth. Bandwidth is currently at or near capacity, with next generation bandwidth still in the future. Yet another issue is a need for standardized software and applications. There is significant technological confusion in the marketplace that causes both uncertainty and increased carrier costs. This confusion causes both carriers and enterprises to be more hesitant about making large-scale investments in what they may perceive to be short-lived technology.

Still another issue is a need for “anywhere” and “anyhow” access to corporate data. Employees are increasingly mobile and require access to corporate information from wherever they are and whenever they need it. PC's are not always available and wireless devices must be able to communicate with corporate applications, including electronic mail and groupware. Still yet another issue is a need for more cost effective devices. Device makers want to standardize on technology that is long-lived, provides consistent user interfaces, and is cost-effective.

One known middleware solution for mobile Java computing is BlueGrid™ middleware available from NTT Software Corporation, Japan. The BlueGrid middleware operates with DoJa KVM (a Japanese version of a virtual machine) on the client side of a mobile Java computing application. In particular, with reference to FIG. 1, flow chart 10 illustrates process steps for a remote method call requested by a mobile client having a DoJa KVM. To begin, the remote method call process 10 executes an OpenHTTPConnection(HostURL) instruction 12. The OpenHTTPConnection(HostURL) is followed by a Connection.setRequestProperty( ) 14 and a Connection.OpenOutputStream( ) 16. This is followed by an OS.Write(BlueGrid Signature) 18, an OS.Write(ObjectID, MethodID, Args) 20, and OS.Serializer(Method Args) 22, OS.Flush( ) 24, and Connection.OpeninputStream( ) 26. Subsequent to the Connection.OpenInputStream( ), a query 28 is made whether or not any error has occurred. If an error has occurred, then the process Throw(IORB Remote Exception) 30 is carried out, ending the remote method call. Alternatively, if no error occurred, then an IS.Read(Return Data) 32, Con.Close( ) 34, and Return(Return Data) 36 are performed. However, the BlueGrid middleware operating with DoJa KVM is not fully suitable for supporting a MIDP profile on a J2ME KVM based mobile device.

Accordingly, it would be desirable to provide an innovative, cost-effective architectural solution for overcoming the problems in the art as discussed above.

### SUMMARY

According to one embodiment, a method of implementing a client side remote method call from a Java-enabled mobile device includes executing an instruction at the mobile device to open a connection at a Host URL. The Host URL includes a server side object of the remote method call. An output stream is opened via the connection. Remote method call parameters are written to the server side remote method call object at the Host URL via the output stream. An input stream is opened via the connection for receiving return data from the Host URL. Lastly, the return data is queried for any occurrence of errors in the remote method call request in response the server side remote method call object and the remote method call parameters, wherein responsive to a detection of errors, remote method call error recovery process is executed for performing a restart of the remote method call in response to at least one recovery query prior to throwing a remote exception which terminates the remote method call. Apparatus for implementing the client side remote method call and a computer program are also disclosed.

### BRIEF DESCRIPTION OF THE DRAWINGS

FIG. 1 is a flow diagram view of process steps in a remote method call for a mobile client device implementing DoJa KVM and operating via a BlueGrid middleware solution;

FIG. 2 is a block diagram view of a wireless mobile messaging architecture according to one embodiment of the present disclosure;

FIG. 3 is a block diagram view of the wireless mobile messaging architecture according to another embodiment of the present disclosure;

FIG. 4 is a block diagram view of a software configuration layer of the wireless mobile messaging architecture according to another embodiment of the present disclosure;

FIG. 5 is a block diagram view of a remote method call process between a client object and a server object according to one embodiment of the present disclosure; and

FIG. 6 is a flow diagram view of process steps in a remote method call for a mobile client device implementing J2ME KVM and operating via a BlueGrid middleware solution according to one embodiment of the present disclosure.

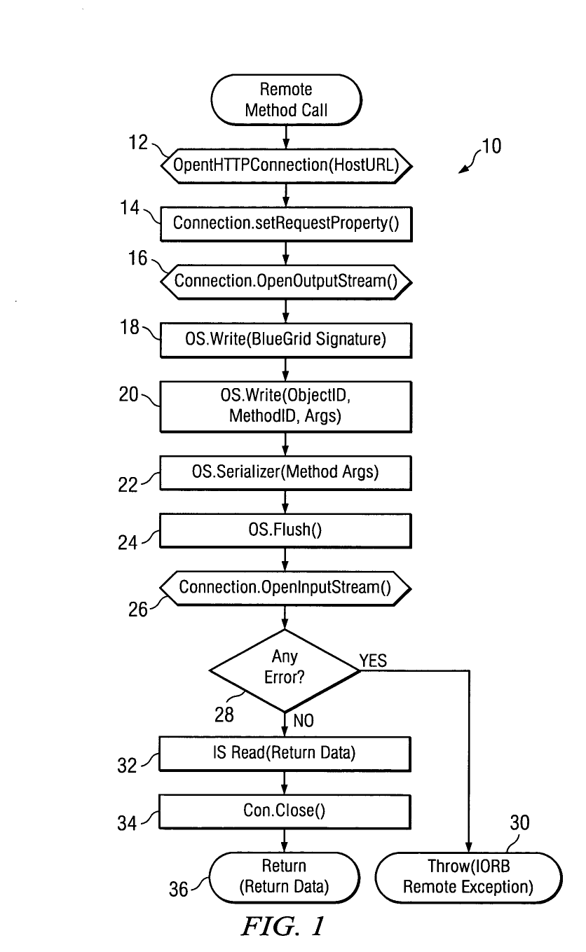

### DETAILED DESCRIPTION

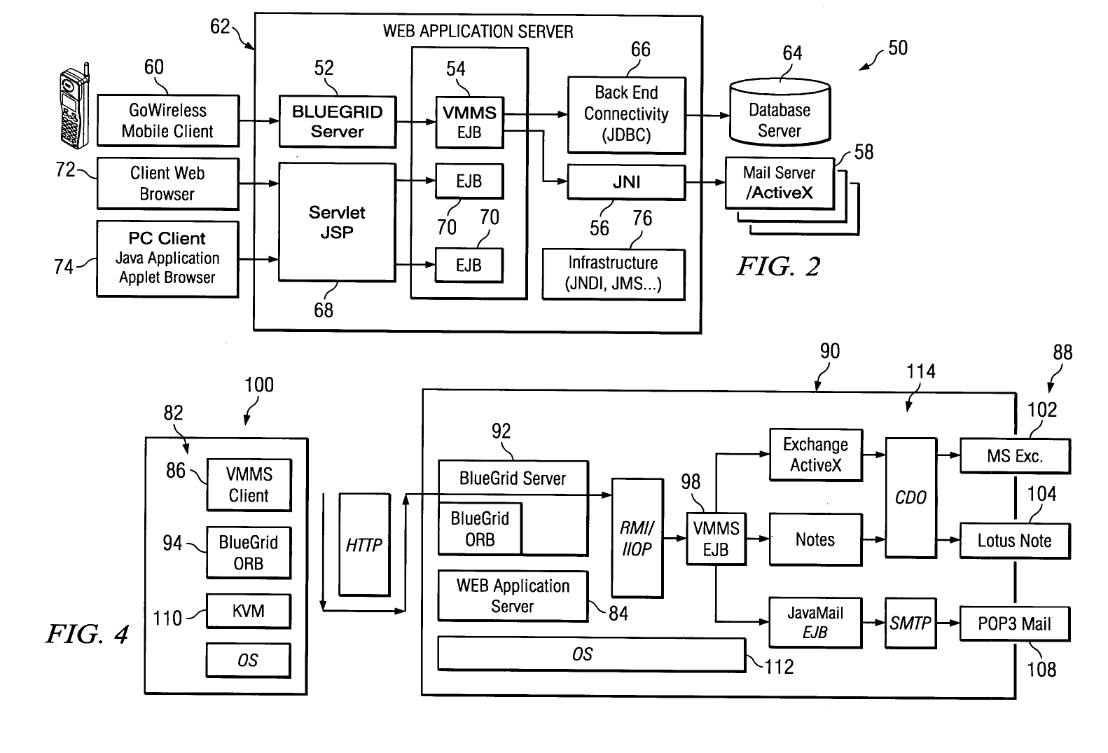

Referring now to FIG. 2, according to one illustrative embodiment, a software architecture for implementing the wireless mobile messaging system 50 includes a BlueGrid™ server software 52, virtual mobile messaging service EJBs 54, a Java Native Interface (JNI) or JaWin DLL 56, a mail server ActiveX DLL or agent 58, and a wireless mobile client application package 60. Installing of the wireless mobile messaging system 50 on an application server 62 includes deploying the virtual mobile messaging service access EJBs 54 and registering the DLLs for corresponding mail messaging servers 58. The web application server 62 also includes a database 64 configured to store user profile information, the database having an object database connectivity (ODBC) or Java database connectivity (JDBC) 66 system data source name that points to the database.

The web application server 62 can also be configured to support the use of a servlet JSP 68 and EJB 70 in connection with a client web browser 72 and a PC client Java Applet browser 74. The BlueGrid server 52 provides access features for the EJB components 70 for a BlueGrid ORB client application. The servlet/JSP layer 68 acts as an intermediary between a Web client and EJB components. Web application server 62 further includes infrastructure 76 (JNDI, JMS, Security, COBRA, . . . ) as may be required for a particular implementation.

Various functionalities of the virtual mobile messaging services (VMMS) application of the present disclosure shall be briefly described herein below. Goals of the VMMS application include one or more of: reducing memory requirements of the VMMS client midlet (Mobile Information Device Applet) to support 2.5G phones (on the order of less than 30K bytes); supporting MIDP handsets, providing full mail service functions (e.g., mail, schedule, task, note, and contacts); and supporting common mail servers (e.g., MS Exchange, Note and POP3).

The VMMS operating environment of the present disclosures can be configured to support access to various mobile messaging server systems, for example, Microsoft Exchange, IBM Lotus Domino, Novell GroupWise, or any other mail system that supports standard POP3/IMAP4 and SMTP protocols. The VMMS operating environment also utilizes a Relational Database Management System (RDBMS) that supports SQL and JDBC/ORBC, a J2EE™ compliant application server, a Servlet environment, a EJB environment, JAVA/Win32 (JAWIN), and BlueGrid Java Communication Middleware. J2EE means Java™ 2 Platform, Enterprise Edition and includes an environment for developing and deploying enterprise applications. JAWIN refers to the interoperation between Java and a component exposed through Microsoft's Component Object Model (COM) or through Win32 Dynamic Link Libraries (DLL).

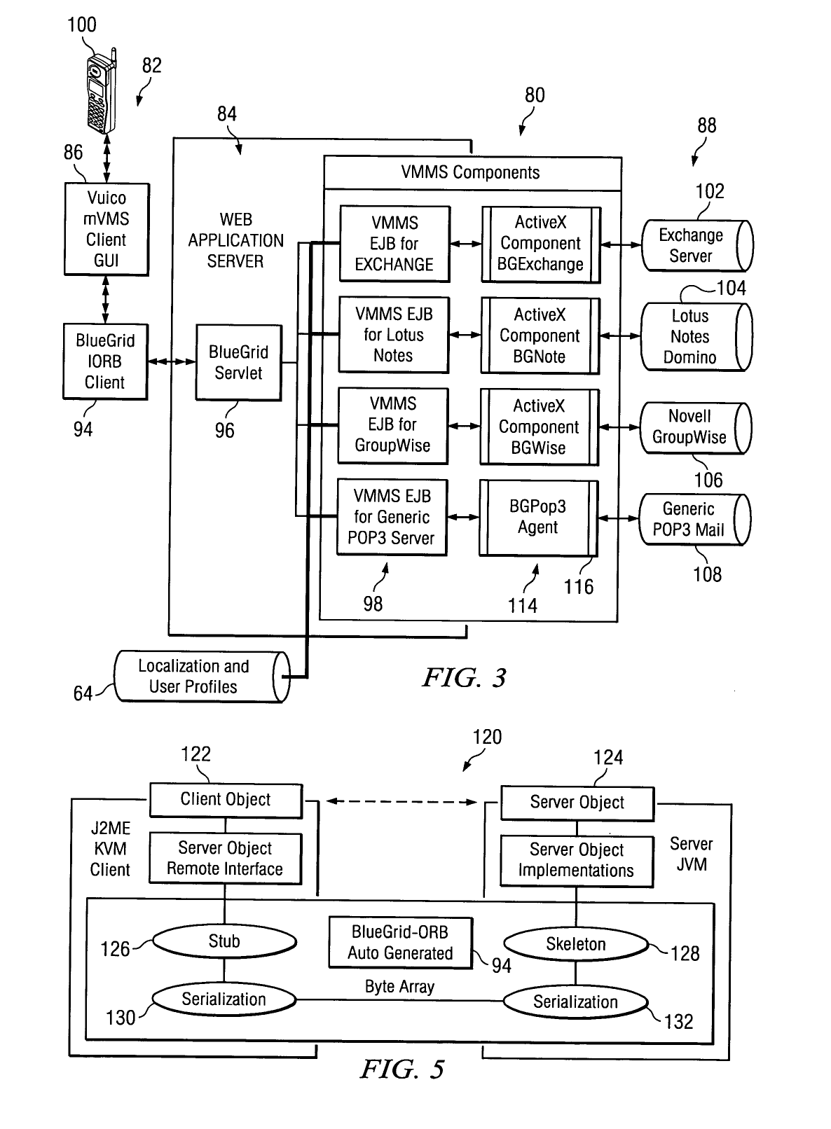

Turning now to FIG. 3, a block diagram view of the virtual mobile messaging system (VMMS) architecture 80 according to another embodiment of the present disclosure and its external dependency components shall be discussed. FIG. 3 is representative of one form of the VMMS physical layout.

Component Data Flow Scenarios

As a client-server application, there are two main components in the virtual mobile messaging system (VMMS) 80 which include a VMMS client 82 and a VMMS server 84. The VMMS Client is a lightweight client to handle the user interface (UI) 86. The VMMS Server is a gateway server that allows mobile client applications to make direct accesses to the desired mail server(s) 88. FIG. 4 is a components diagram 90 of the VMMS application, which contains both client 82 and server 84 of VMMS 80 and its external dependency software components. FIG. 4 illustrates one form of the VMMS software configuration layer.

In one embodiment, the VMMS server 84 includes a BlueGrid server, the BlueGrid server providing a gateway feature between the BlueGrid ORB and RMI/IIOP allowing J2ME CLDC applications to access the Enterprise Bean component in the same way as the J2SE applications access the Enterprise Bean component. Main features of the BlueGrid server include: J2EE specification compliance, scalable high performance, transparent cooperation, and auto-generation of the gateway application.

The BlueGrid server configuration performs two distinct roles. For a client application using HTTP communication (e.g., a MIDP application), the BlueGrid server operates in the application server servlet environment. For a client application using TCP/IP socket communication (e.g., applications on Palm OS), the BlueGrid server operates as a stand-alone application server EJB gateway to allow client remote procedure access to the server EJB through JNDI and Java RMI/IIOP. Accordingly, the BlueGrid server executes multiple communication protocols, including the BlueGrid ORB protocol between client and BlueGrid Servers and the RMI/IIOP protocol for calling the EJB components from a BlueGrid Server.

In connection with the VMMS software configuration layer 90 of FIG. 4, data flow of the VMMS application is carried out with the use of multiple protocols and formats. The following table summarizes protocols and formats, for use when passing data from one component to another in the VMMS application, according to one embodiment.

VMMS data flow protocols and format

| | Protocols | Data Format |
|---|---|---|
| VMMS Client | | |
| BlueGrid Servlet | HTTP/HTTPS | String byte array |
| VMMS EJB | RMI/IIOP | String |
| JAWIN DLL | JNI DLL | Java Object |
| VCMM ActiveX (VB DLL) | C Function library call | C Object |
| Mail Server (Exchange) | ODO | COM Object |

Client Components.

According to one embodimentt, the VMMS client application 82 is loaded and executed from a J2ME™ MIDP profile device. In another embodiment, a J2ME/CLDC profile is used. With respect to the J2ME/CLDC profile, because of limited resources in J2ME/CLDC mobile devices, in particular, 2.5G phones, the VMMS client application 82 size must be less than 30K bytes. J2ME means Java 2 Platform, Micro Edition and includes a group of specifications and technologies that pertain to Java on small devices. J2ME covers a wide range of devices, from pagers and mobile telephones through set-top boxes and car navigation systems.

The client application 82 contains two main components. The Mobile Client component 86 is a Java based application, which runs on the mobile device to handle the user interface and enable the communication with the BlueGrid-Server 92 through the BlueGrid-ORB 94. The BlueGrid-ORB 94 Client component is a Mobile Java Communication middleware to handle the application HTTP/HTTPS communication with the BlueGrid-Server 92. Hypertext Transfer Protocol (HTTP) is an Internet protocol used to fetch hypertext objects from remote hosts. HTTP messages consist of requests from client to server and responses from server to client. In addition, Secure Sockets Layer (SSL) is a protocol for transmitting private documents via the Internet. SSL works by using a public key to encrypt data that's transferred over the SSL connection. Accordingly, HTTPS messages consist of requests from client to server and responses from server to client that require an SSL connection.

Server Components

The VMMS server components are run on the application server 84. Their main function is to provide access to the desired mail service(s) 88 to/from the VMMS client 82. There are three main server components. A first component includes a BlueGrid-Server 92, which runs as a servlet 96 (FIG. 3) and offers a gateway feature between a BlueGrid-ORB client 94 and an Enterprise Java Bean (EJB) 98. Accordingly, the Bluegrid server 92 allows the J2ME/CLDC application of the mobile device 100 to access the EJB components 98. The VMMS EJB component(s) 98 handles client requests. That is, the EJB component 98 receives the user's request from BlueGrid servlet 96 in the string format. The BlueGrid servlet 96 converts the string request to a Java object and sends the request object to the JaWin DLL through JNI (Java Native Interface) 56 (FIG. 2). JaWin DLL passes the request to the VMMS ActiveX 58 (FIG. 2). JaWin DLL converts received Java objects to C objects and calls the VMMS CLIENT ActiveX 58 (FIG. 2) through a C function call. The VMMS CLIENT ActiveX 58 sends the request to mail server 88 (e.g. an MS Exchange server 102). The VMMS CLIENT ActiveX 58 converts the received C object to a DOM object, and sends the request object to the mail server 88.

The VMMS 90 includes a client-server architecture application that operates under a J2EE environment. The VMMS 90 will support multi-user interaction, since its operating environment and its DLL are supported multiple threaded. Multiple users can access the VMMS application at the same time.

Security Considerations

According to another embodiment, security is a requirement in many aspects of the VMMS client server application 90 product. The MIDP profile version and Java version are selected to support SSL. In addition, the VMMS is configured to support HTTPS protocol.

Referring again to FIG. 3, WEB Application Server 84 may include any suitable web application server, for example, but not limited to: BEA WebLogicâ Application Server; IBM WebSphereâ Application Server; Javaä 2 Platform, Enterprise Edition Server; Oracle 9iâ Application Server; Sun Microsystems iPlanetâ Application Server; or other suitable server.

Mails Servers 88 can include any suitable mail servers, for example, but not limited to: Microsoftâ Exchange Server 102; IBMâ Lotus Dominoâ Mail Server 104; Novell GroupWiseâ 106; Mail Server systems that support POP3/SMTP 108; and Mail Server systems that support IMAP/SMTP.

According to one embodiment, the wireless mobile platform and mobile messaging architecture operate as follows. Wireless devices, such as a handset or PDA 100 contain two code sets. The first code set is the wireless mobile client 82 and the second is software unique to each application that must run on the wireless device. The wireless mobile client is the software that enables all communications with the BlueGrid server and beyond to the messaging server application, such as MS Exchange™. The wireless mobile client 82 is very small, requiring on the order of approximately 2-8K of device memory. In one embodiment, the wireless mobile client 82 is burned into the device chipset of a respective wireless device. In another embodiment, the wireless mobile client 82 is downloaded by a carrier or the mobile device manufacturer to the device memory of the wireless device, for example, from a website or via an over-the-air provisioning program.

One advantage of the wireless mobile client 82 of the VMMS architecture 80 is its simplicity. Rather than requiring wireless devices with limited memory and processor speed to assume the full functionality of J2ME, the wireless mobile platform relegates most of the J2ME processing to the BlueGrid server 52 (FIG. 2). The wireless devices are left to focus on their respective unique functionality. Accordingly, this provides a performance, maintainability, and cost-benefit to the wireless device manufacturer and its customers.

Referring again to FIG. 4, according to one embodiment, the wireless mobile client 82 includes an Object Request Broker (ORB) 94. The ORB 94 of the wireless mobile client communicates with a BlueGrid ORB running on the BlueGrid server 92. The wireless mobile client ORB 94 also utilizes a MIDP (mobile information device profile) and Java KVM (Sun Microsystem Java's Virtual Machine) software that are pre-configured to operate and already present and operational on the wireless mobile device 100. In addition, on top of the wireless mobile client resides software unique to each application that runs on the wireless mobile device (to be discussed further herein below).

With respect to wireless mobile messaging according to one embodiment of the present disclosure, the wireless mobile messaging application resident on the wireless device or handset 100 includes a GUI 86 and dialog. The GUI 86 and dialog are necessary to retrieve or develop and send information such as email, calendar information, etc. The GUI and dialog of wireless mobile messaging applications require on the order of about 25K of device memory on the wireless device, which is much less than browser-based application, and furthermore, much less than browsers themselves. In addition, the wireless mobile messaging applications enable browsing through multiple remote, over-the-air menus. Because browsing through multiple remote, over-the-air menus is utilized, sending and receiving information is much quicker and uses much less network bandwidth. The wireless mobile messaging software on the wireless mobile device also runs in binary fashion, requiring much less data translation than browser-based systems need.

The BlueGrid servlet 96 is a communications point for the wireless client software of the wireless mobile device 100. The BlueGrid servlet 96 includes an ORB that communicates with the client ORB 94 and the Java Virtual Machine (JVM) software 110 (FIG. 4) of the wireless mobile device 100. The JVM software 110 is core Java software required by Java servers. The BlueGrid servlet 96 runs on any web applications server and resides atop the respective web application server's operating system 112.

In one embodiment, the BlueGrid servlet 96 handles what used to be required on limited-capacity wireless devices, that is, in connection with the J2ME specification (Java 2 Mobile Environment). Note that the J2ME specification is very robust. With respect to prior limited-capacity wireless devices, placing all the J2ME required code on a handset, for example, proved to be sometimes impossible, and furthermore, very often too taxing for the handset's processor. In connection with the wireless mobile architectural model of the present disclosure, much of the J2ME processing is moved onto the BlueGrid servlet 96, accordingly, leaving the client 82 of the mobile wireless device 100 as thin as possible.

Further in connection with the wireless mobile platform of the present embodiments, the wireless mobile platform 80 includes an EJB backend (54, 98) configured to communicate with the corresponding server based messaging application 88. In one embodiment, the EJB backend 98 communicates with an ActiveX application 114 residing on a respective messaging application server platform 88. The ActiveX component 114 includes API's necessary to move data between the messaging application of the messaging server 98, the BlueGrid middleware 92, and ultimately, the wireless device 100. Since many Microsoft applications, as well as other messaging applications, do not communicate directly with Java, but instead employ ActiveX, the EJB code 98 is configured to translate Java to ActiveX. Accordingly, the EJB code allows the communications with the specific application to occur more naturally. In the case where ActiveX is not required, according to one embodiment, the wireless mobile architecture includes an application-specific agent 116 configured to be run on the messaging application's server platform.

In addition to the agent 114 residing on the messaging application's server, the wireless mobile architecture includes XML to EJB software. The XML to EJB software takes XML data from the wireless mobile device and places it in a format required by the EJB software. The EJB software provides a Java front-end to the messaging application (e.g., Exchange 102), in connection with the ActiveX component or agent as discussed above. In reverse, the XML to EJB software takes the EJB data and converts it to appropriate XML data.

Since the wireless mobile messaging architecture is server-powered, it provides a full set of messaging capabilities. For example, the messaging capabilities can include read, compose, reply, reply all, and forward. The messaging capabilities can also include corporate address look-up, cut and past into address fields, allowing no need to type in email addresses. Still further, the messaging capabilities can include access to the wireless device's local address book, however, such additional messaging capabilities may need to be accomplished via device-specific modifications, further including security considerations.

The wireless mobile messaging architecture can also provide calendaring capabilities. Calendaring capabilities include, for example, an ability to view and schedule meetings with other users of the server-based or network messaging application, to-do's and lists. The wireless mobile messaging architecture leverages the strengths of the network and the applications servers on which the messaging applications run.

In connection with the wireless mobile architecture of the present disclosure, additional security features for the mobile device can also be provided. Such security features may include, for example, a session timeout so that for a mobile device which has been left on and unattended, email cannot be downloaded, nor calendars viewed on the network. In addition, email and other information is not retained once the mobile device is turned off, accordingly, preventing any unauthorized access to that information if the mobile device becomes lost or stolen.

The wireless mobile architecture of the present disclosure facilitates performance features that can include, for example, the use of thin client devices which minimizes network traffic, enables fast response times over the network, ability to support large enterprise users or subscribers, and a substantially direction connection to the network server-based messaging application.

The wireless mobile architecture further provides usability features that include, for example, direct connect with no need to sync, no sync problems, mail, address books always available, and no need for any SyncML (SyncML is an emerging XML-based standard for synchronizing devices and applications over a network). The wireless mobile architecture eliminates information synchronization across management devices. The mobile messaging architecture GUI for the wireless device more closely reflects a typical session of a corresponding server-based messaging application, resulting in the GUI being easy to learn and use. Other usability features include simple cut and past for inserting address book entries in email address lines, and the use of full color capabilities when available on the handset, such as color graphics for a monthly calendar view.

Unlike other wireless email systems, the wireless mobile messaging system according to one embodiment of the present disclosure provides a secure, direct connection to a server-based messaging application system, such as a corporate system. No synchronization is required between a user's mobile handset or wireless device and the user's PC. Furthermore, no synchronization software is required on the user's PC.

For mobile devices having address books, synchronization is well suited for populating the address books from tethered PC's or wireless portals, however, not for email. In addition, synchronization presupposes that the synchronized elements are to remain on the handset which creates a security problem if the handset is lost or stolen. Synchronization also requires handset driver software, which makes it difficult to acquire new handsets and obtain its numerous benefits if appropriate software has not been released. Lastly, synchronization sessions often prematurely abort, leaving the mobile device in an indeterminate state in which it is unclear to the user which emails were synchronized and which ones were not. This can result in duplicate or missing emails on the mobile device. The wireless mobile architecture according to the present disclosure does not suffer from any of these synchronization problems and, accordingly, provides full functionality of a respective server-based messaging application without synchronization problems.

A number of wireless corporate email access products require re-direct software on user's PCs. The re-direct software adds another dimension of complexity and configuration to corporate information technology (IT) staff. However, the wireless mobile architecture of the present disclosure does not require such re-direct software on a user's PC. The software of the wireless mobile architecture resides in the client GUI and/or on the wireless mobile architecture application server. Accordingly, the software can be cleanly managed by the corporate IT staff or the service provider, depending on the particular implementation. In addition, the end user need not worry if a PC is on or off, or if software is loaded or not. Furthermore, the end user also does not have to worry if he/she redirected emails to the wireless device or not.

In addition to the above, it is noted that browser-based wireless messaging systems have their own set of problems. For example, all menuing is host-based. That is, the end user selections must go to the web server and be acted upon before the first email or calendar item is retrieved from the server-based messaging application. In contrast, the mobile messaging client resident on the wireless device of the wireless mobile architecture of the present disclosure handles all menuing internally on the mobile device. The mobile messaging client only sends the final command to the email host (with no web server in the middle) to make more work for the user or add additional overhead to the network.

Accordingly, the wireless mobile messaging platform of the present disclosure offers advantages that other wireless technologies can not. The advantages provide solutions to major problems that are making it difficult for wireless carriers, device makers, enterprises and wireless solution providers to deliver “real” wireless Internet solutions the offer a very satisfying yet very secure Internet experience to their subscribers and mobile users.

Additional advantages of incorporating the wireless mobile architecture into a wireless services technology base include: taking advantage of advanced wireless network capabilities; providing foundation software and architecture suitable for meeting next generation wireless applications and features, such as videophones, and voice command operation; building to a global standard, making global markets more accessible; and minimizing the need for carriers to install and maintain a very expensive network infrastructure, while being able to offer new and useful revenue-generating wireless Internet and m-Commerce services to subscribers.

According to another embodiment, the wireless mobile messaging application software configuration layer includes a number of components as follows. A mobile messaging client interface is provided on the mobile device or handset to manage the messaging presentation. In particular, the handset includes a java enabled device, with KVM/MIDP and a BlueGrid ORB. BlueGrid Gateway Components are provided on a web application server to manage and process all requests from the mobile device and is configured to interface with the BlueGrid Server. A Java to messaging service utility or agent (e.g., Java to MS Exchange) converts Java requests to messaging service compliant requests of a corresponding messaging server. The utility also interprets Java and messaging service calls. In one embodiment, the Java to messaging service utility is implemented in the form of a RPC (remote procedure call). Lastly, the messaging server serves and stores messages and other information. For example, one illustrative messaging server includes any data center or server running standard MS Exchange, with no modification to MS Exchange needed.

Further in connection with one embodiment of the present disclosure, mobile messaging clients are created to support a corresponding messaging server. For example, in a suite of wireless mobile messaging software products that includes access to one or more of Microsoft Exchange server 102, Lotus Domino server 104, GroupWise server 106, and mobile POP3 mail server 108, a corresponding mobile messaging client is provided. The mobile messaging clients include a wireless Exchange mobile messaging client, a wireless Notes mobile messaging client, a GroupWise mobile messaging client, and a mobile mail server messaging client, respectively. In one embodiment, the wireless mobile application package containing the corresponding mobile messaging clients can be delivered to appropriate web application servers for installation thereon via a CD-ROM or via web/FTP sites.

FIG. 5 is a block diagram view of a remote method call process 120 between a client object 122 and a server object 124 according to one embodiment of the present disclosure. As discussed herein, the BlueGrid ORB 94 allows for easy setup of a client/server application. The use of the remote method call in the BlueGrid ORB 94 full features version library is similar to that of the Java RMI. Both have similar preprocessors that generate the stub classes 126 and skeleton classes 128. In other words, the remote method call to the server object is operated using the stub class and skeleton class generated by a stub generator. The stub class 126 marshals (serializes 130) remote method parameters to the remote skeleton class through the network, and unmarshals (de-serializes 130) the return value from the remote method. On the other hand, the skeleton class 128 unmarshals the parameters, calls the directed method, and marshals the called method return value to the stub class 126. An object registry of the BlueGrid ORB on the server side holds the names of the objects and provides a naming service for BlueGrid clients. In this manner, the remote objects of the BlueGrid ORB perform in a similar way to that used in JNDI.

In other words, when passing an object via the remote method call argument, the client side ORB 94 converts the object to a byte string using an appropriate serializer class 130, and forwards the object to the server through the network. The receiving server side ORB 94 uses the appropriate serializer class 132 to restore the object, and passes it on to the server object method as an argument. Objects sent back as the returned value of the remote method retrace these steps in reverse to reach the client object.

Furthermore, the BlueGrid ORB 94 uses only one exception (e.g., lorbRemoteException) in response to the limited memory resourses in the J2ME CLDC environment. The remote method must always be defined to throw this exception. The remote method must not be defined to throw any other exceptions. If another exception occurs in the remote method that needs to be communicated to the client, the contents should be set to IorbRemoteException and thrown. Accordingly, the client application should receive all exceptions that occur in the remote method call as IorbRemoteException. Still further, with the remote method call, there is the possibility that exceptions may be thrown from communication anomalies, in addition to exceptions from the remote method.

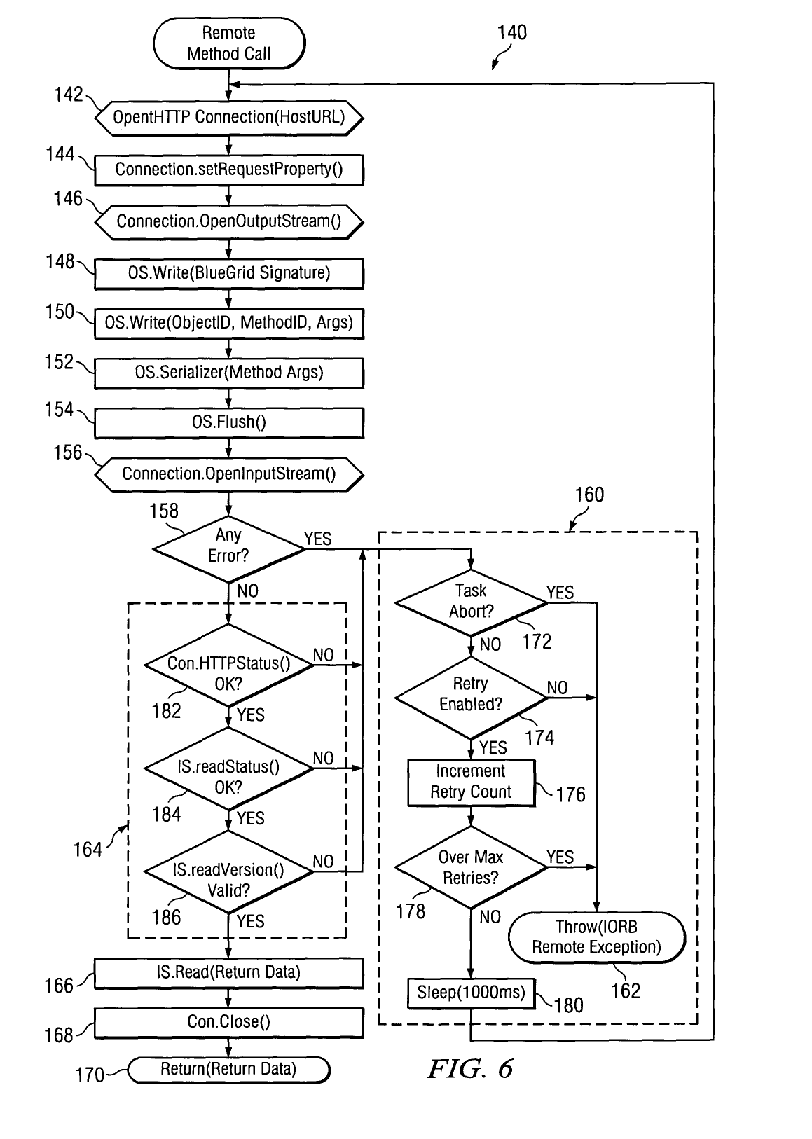

FIG. 6 is a flow diagram view of process steps in a remote method call 140 for a mobile client device implementing J2ME KVM and operating via a BlueGrid middleware solution, according to one embodiment of the present disclosure. In this embodiment, the BlueGrid middleware operates with J2ME KVM on the client side of a mobile Java computing application. In particular, with reference to FIG. 6, process steps for a remote method call with a mobile client having a J2ME KVM include steps as follows. To begin, the remote method call 140 executes an OpenHTTPConnection (HostURL) instruction 142. The OpenHTTPConnection (HostURL) 142 is followed by a Connection.setRequestProperty( ) 144 and a Connection.OpenOutputStream( ) 146. This is followed by an OS.Write(BlueGrid Signature) 148, an OS.Write(ObjectID, MethodID, Args) 150, and OS.Serializer(Method Args) 152, OS.Flush( ) 154, and Connection.OpenInputStream( ) 156.

Subsequent to the Connection.OpenInputStream( ) 156, a query 158 is made whether or not any error has occurred. If an error has occurred, then the process proceeds via an error handling process 160, without directly executing a Throw(IORB Remote Exception) 162 and ending the remote method call. Alternatively, if no error occurred, then a number of additional queries 164 are performed and handled, prior to performing an IS.Read(Return Data) 166, Con.Close( ) 168, and Return(Return Data) 170. As a result, the BlueGrid middleware is made suitable for supporting a MIDP profile on a J2ME KVM based mobile device, as contrasted to a mobile device operating with DoJa KVM.

Referring back to query 158, if an error has occurred, then the process proceeds with error handling process 160. According to one embodiment, error handling process 160 includes the steps of querying whether to abort the task at 172, querying whether a retry is enabled at 174, incrementing a retry counter at 176, querying whether a maximum limit of the number of retries has been reached at 178, and executing a pause or sleep mode for a given limited duration at 180.

At 172, if the task abort query results in not to abort, then the process continues to step 174. If the task abort query results in an abort of the task, then the process ends at step 162, Throw(IORB Remote Exception). At 174, if a retry on the occurrence of an error is enabled, then the process proceeds to step 176, wherein a retry counter increments a retry count. At 174, if a retry is not enabled, then the process ends at step 162, Throw(IORB Remote Exception). At step 178, if the over max retries query indicates that a maximum number of retries has not occurred, then the process proceeds to 180. However, if at step 178 the over max retries query indicates that a maximum number of retries has occurred, then the process ends at step 162, Throw(IORB Remote Exception).

At 180, the process enters a pause or sleep mode. In one embodiment, the sleep mode has a predetermined duration, for example, on the order of 1000 ms. Other durations may be used as appropriate for a given application. Subsequent to the sleep mode, the remote method call process repeats, beginning again at step 142 and executing an OpenHTTPConnection(HostURL) instruction.

Referring back to 158, if no error occurred, then a number of additional queries 164 are performed and handled, prior to performing an IS.Read(Return Data) at 166, Con.Close( ) at 168, and Return(Return Data) at 170. One or more of the additional queries can be carried out, as appropriate, for a given implementation. For example, at 182, the process includes the query whether the Con.HTTPStatus( ) is ok. If the Con.HTTPStatus( ) is not ok, then the process advances to the error handling at 160, as discussed above. However, if the Con.HTTPStatus( ) is ok, the process proceeds to step 184. At 184, the IS.readStatus( ) is queried. If the IS.readStatus( ) is not ok, then the process advances to the error handling at 160, as discussed above. On the other hand, if the IS.readStatus( ) is ok, then the process advances to step 186. At 186, a query to check the validity of the IS.readVersion( ) is performed. If the IS.readVersion( ) is not valid, then the process advances to the error handling at 160, as discussed above. If the IS.readVersion( ) is valid, then the process proceeds to the IS.Read(Return Data) 166, Con.Close( ) 168, and Return(Return Data) 170.

Accordingly, the remote method call procedure 140 of the present disclosure enables the BlueGrid middleware to be made suitable for supporting a MIDP profile on a J2ME KVM based mobile device. Changes include those as discussed herein above with respect to the remote method call procedure 140 and are made to the client side of an application to support the J2ME/MIDP profile. The changes include modification of the disconnect method of the EJBClient class to allow an application to delete a current EJBClient object and generate a new object for handling a login error. In addition, the Stub method call and IORBClient lookup methods are modified to allow operation, abort, retry, and preserve the exception message when a retry on error is enabled.

According to another embodiment of wireless mobile messaging service architecture of the present disclosure, a packet protocol is defined for two types of packets, a detail packet and a summary packet. The detail packet includes a version, a packet field delimiter value, packet type value, item ID, header, status, field count, and field detail. The version includes any string value that indicates the packet version. The packet field delimiter value includes an integer value (2 bytes) that is divided into two parts, a first set of bits for identifying modification flags (bit-wise) and a second set of bits for enumerating the Packet ID type. Modification flags may include one or more of summary, new, update, delete, forward, reply, reply_all, look-up, as well as others, for example. The packet ID type may include an ID type enumerated for one or more of a folder, schedule, mail, note, contact, task, monthly summary, mail folder, default, or others, for example. The Item ID may include a string containing a unique ID of a detail object, for example, mail, contact, etc. The Header includes a string that is displayed by the client device. Status includes a “Passed” or “Failed” message. Field count and Field detail include the number of field records following and their formats, respectively. The Field detail format may includes a string of a field type, field name, and field value.

The summary packet includes a version, packet field delimiter value, packet type value, item ID, header, status, packet count, and detail packet. The version, packet field delimiter, packet type, item ID, header, and status are similar to that of the detail packet. The packet count refers to the number of packets to follow. The detail packet can be either a Detail or Summary Packet, depending upon a Summary flag.

The Client's side return packet shall now be briefly discussed. The EJB always returns to the Client in an array of String format, a Version, Packet Type (Modification flag+Packet Type), Item Id, Header, Status, Item Count, and then the first item, second item, etc. If Item count is zero (0), then the string array ends, else the string continues for the number of items in the item count.

With respect to the Client's side return packet, the item content depends on the packet type and the summary flag. If the summary flag is set, then each item contains a fully qualified packet. If the packet type is Folder request, then the item's packet is a summary packet. Or if the packet type is schedule summary, then the item's packet is detail packet. For example, in one embodiment, the Client sends the following packet to the Server: Default, Folder Summary, Mail Summary, Schedule Summary, Contact Summary, Note Summary, Mail Folder Summary, and Mail Detail. The Server responds with the same packet request and the appropriate result. For Schedule, Contact, and note, the details are also sent back inside the Summary Packet.

Special cases are noted as follows. With respect to the Folder Summary, the server returns a summary packet listing all the count for mails, schedules, contacts and notes with the item detail packet set to zero (0) count. With respect to the Mail Summary, the server returns a summary packet type equal to Mail Folder and the item packets will contain zero (0) fields. Accordingly, the client has to request Mail for each mail Id in order to display the mail contents. With respect to Mail Detail, the server will return a summary packet with one (1) packet in the item. The encapsulated packet will be a Mail detail packet with the appropriate number of fields.

The following is an illustrative example of packet process flow according to one embodiment of the present disclosure, wherein the mail server includes a Microsoft Exchange mail server. Responsive to a login by the Client, the Server performs a lookup of the user id from a database, using the username/password. The server then looks up the domain/Exchange folder from the database and using the User Id, performs a login to the Exchange Server. If successful, the server retrieves the last valid summary packet stored and its content's buffer size setting. The server then returns True or False to the client.

In response to the client submitting a request to send a default, the server responds as follows. If the last summary packet is not valid, then it returns the folder summary from Exchange to the Client. In addition, the server saves the folder summary as the default packet. Otherwise, the server performs one of the following: return mail summary from Exchange, or return schedule summary from Exchange, or return note summary from Exchange, or return contact from Exchange. In response to the client submitting a send folder request, the server returns a folder summary packet. Responsive to the client submitting a send mail summary, the server returns a mail folder summary packet. Responsive to the client submitting a send schedule packet, the server returns a schedule summary packet.

With respect to templates, a client can request a template for Mail, Schedule, Contact or Note, however, the client request would also need to send an appropriate packet with a NEW flag set in the package type field, Item Id=“0” and the item count=0. In response, the Server responds with the appropriate detail packet and the NEW flag cleared. The packet will be encapsulated inside a MAIL Summary packet with 1 Item count and the item is the detail packet itself.

According to one embodiment of the present disclosure, the wireless mobile platform provides wireless carriers, device makers, enterprises and wireless solution providers one or more of the following advantages: usage of standards-based technology, high performance, applicability to thousands of applications, proven technology and scalability, reduced device memory requirements, and convergence of different devices. With respect to standards-based technology, the wireless mobile platform is JAVA-based and enjoys all the JAVA advantages, including robust standards and long life. With respect to high performance, the thin client-server model reduces network dialog between wireless devices and applications, provides improved response time to the user and better utilizes the carrier's network bandwidth.

With respect to server-based messaging applications, there are literally thousands of applications that can be ported to the JAVA-based environment, providing carriers and enterprises numerous available applications for almost any requirement. With respect to proven technology and scalability, one embodiment of the present disclosure utilizes a Java platform (J2EE/J2ME Client/Server environment) and BlueGrid mobile Java communication middleware technology. With respect to mobile device memory, the client-server model of the present embodiments requires very small amounts of device memory, thus making devices either less expensive to produce or enables more features at the same price point. Lastly, with respect to convergence of devices, JAVA is an equalizer, that is, enabling convergence of PDA's and handsets, by providing a same look and feel to the user.

Carriers that deploy the wireless mobile platform of the present disclosure can receive one or more benefits. Such benefits include a competitive advantage and new sources of revenue. Incorporating the wireless mobile platform of the present disclosure into existing application web servers offers true mobile computing solutions that carrier or enterprise competitors cannot easily duplicate. For example, integrating the wireless mobile platform with existing wireless platforms offers rapid development of web services for mobile-commerce (m-commerce) portals, enabling carriers or enterprises to quickly extend portal services to subscribers or mobile users. More immediately, it delivers mobile access to corporate data with resulting productivity benefits. With respect to new sources of revenue, the wireless mobile platform of the present disclosure offers the ability to accelerate new revenue growth through the rapid introduction of useful new mobile applications and services, for example, by reducing time to market for new wireless solutions and reducing overall development costs. The wireless mobile platform solution offers a major opportunity to deliver true wireless applications and content to virtually all-wireless devices, thereby substantially increasing market share.

The wireless mobile platform also includes an application suite supportive of mobile messaging for an enterprise. The application suite includes applications that enable mobile users to access not just e-mail, but also calendars, contacts, notes and tasks. Because the wireless mobile platform runs on the BlueGrid client-server wireless middleware technology, the application suite allows users to enjoy the full features and benefits of a respective application on a handset or PDA. Applications may include, for example, Microsoft Exchange, Lotus Domino, and others. The wireless mobile platform enables the full features of the respective application on a handset or PDA without requiring a browser. Accordingly, the wireless mobile platform ensures consistency, performance, and an ability to quickly upgrade without requiring handset or PDA changes.

Unlike other solutions where one can only access e-mail, the wireless mobile platform of the present embodiments also enables access to appointments, contacts, and any functions that are available in a respective messaging server application (e.g., Microsoft Exchange or Lotus Domino). Such access with the wireless mobile platform of the present embodiments is possible in real-time, offering a truly pleasant wireless Internet experience.

According to one embodiment, the wireless mobile messaging suite of software applications includes an Exchange mobile messaging client, a Notes mobile messaging client, a GroupWise mobile messaging client, and a mobile instant messaging client. The wireless mobile platform of the present disclosure also utilizes a thin-client approach. Accordingly, the mobile messaging client software resident on a mobile device occupies very little of the application memory on such devices. The mobile devices include, for example, cellular phones, PDA's and pocket PC's. In addition, each client is supported by a server component resident upon a web application server, the server component being included within the wireless mobile messaging suite of software.

With the wireless mobile platform architecture of the present disclosures, applications and content are centralized and automatically kept current without user intervention. Since both content and applications are server based, the content and applications are readily available for access anytime, anywhere and irrespective of mobile device and network. Wireless Internet access that is network agnostic, meaning Internet access is not dependent on a device or network, is a fundamental value of the wireless mobile platform of the present disclosure. Accordingly, the wireless mobile platform can be built to run on various wireless networks, such as GSM, CDMA, TDMA, and i-mode, among others, with MIDP protocols, as well as, DoJa.

In addition, if an enterprise or carrier maintains a website, applications, and Internet content completely secured in one or more application servers of its data center, then the enterprise or carrier can select a desired choice of wireless client device, be it a cellular phone or PDA, and is able to maintain reliable voice and data connectivity and communications between different networks and platforms. The wireless mobile platform of the present disclosure provides mobile users who want text-based messaging on their mobile device with the same freedom and unlimited access of voice communications.

The wireless mobile platform of the present disclosures is an innovative wireless solution that delivers access to applications and content, independent of the location or wireless device. The wireless mobile platform and mobile messaging architecture offers true wireless convergence. Features include accessing the same current information, no matter which device is used. Data becomes truly portable. According to one embodiment, the wireless mobile platform architecture is based on a Java J2ME CLDC MIDP profile, providing portability among various devices.

As discussed herein, wireless mobile messaging of the wireless mobile messaging platform is a Java “client-server” application that runs on BlueGrid communication middleware and J2EE/EJB environment. The wireless mobile messaging method enables mobile devices to access not just e-mail, but also calendars, contacts, notes and tasks from a corresponding messaging server or servers. The Java “client-server” application enables access to the full features and benefits of mail server applications, such as Microsoft Exchange, Lotus Domino, and many others, to become available on a handset or PDA.

In one embodiment, a method of implementing a client side remote method call from a Java-enabled mobile device includes executing an instruction at the mobile device to open a connection at a Host URL, the Host URL including a server side object of the remote method call. An output stream is opened via the connection. Remote method call parameters are written to the server side remote method call object at the Host URL via the output stream. An input stream is then opened via the connection for receiving return data from the Host URL. Lastly, the return data is queried for any occurrence of errors in the remote method call request in response the server side remote method call object and the remote method call parameters.

Responsive to a detection of errors, the method executes a remote method call error recovery process for performing a restart of the remote method call in response to at least one recovery query prior to throwing a remote exception which terminates the remote method call. In addition, responsive to an affirmative recovery response of the at least one recovery query, the remote method call error process restarts the remote method call over at the step of executing the instruction at the mobile device to open a connection at the Host URL. In one embodiment, the remote exception is a lightweight object request broker (IORB) remote exception.

Responsive to non-detection of errors, the method further includes querying at least one selected from the group consisting of a connection status query, an input stream status query, and an input stream read version validity query, wherein responsive to a negative or invalid status of a corresponding query, executing the remote method call error recovery process for performing a restart of the remote method call in response to the at least one recovery query prior to throwing the remote exception which terminates the remote method call.

The remote method call error recovery process includes recovery queries, the recovery queries including at least one selected from the group consisting of a task abort query, a retry enabled query, and a retry limit query. Responsive to a) a result of the task abort query being abort or b) a result of the retry enabled query being non-enabled or c) a retry count exceeding the maximum number of retry attempts, the remote method call error recovery process throws the remote exception, thereby terminating the remote method call.

Responsive to a result of the task abort query being not to abort, the remote method call error recovery process further including the retry enabled query. Responsive to a result of the retry enabled query being enabled, the remote method call error recovery process further includes incrementing a retry count in response to the retry being enabled. The retry limit query occurs subsequent to the retry enabled query and the incrementing of the retry count. Responsive to the retry count not exceeding a maximum number of retry attempts, the remote method call error recovery process further includes executing a sleep mode prior to restarting the remote method call. In one embodiment, the sleep mode includes a pause on the order of 1000 ms. The remote method call error recovery process further includes executing the sleep mode prior to restarting the remote method call.

According to another embodiment, a Java-enabled mobile device includes a processor and which is programmed via a computer program for performing functions as described herein, using programming techniques known in the art.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method of implementing a client side remote method call from a Java-enabled mobile device, comprising:
executing an instruction at the mobile device to open a connection at a Host URL, the Host URL including a server side object of the remote method call;
opening an output stream via the connection;
writing remote method call parameters to the server side remote method call object at the Host URL via the output stream;
opening an input stream via the connection for receiving return data from the Host URL; and
querying the return data for any occurrence of errors in the remote method call request in response the server side remote method call object and the remote method call parameters, wherein responsive to a detection of errors, executing a remote method call error recovery process for performing a restart of the remote method call in response to at least one recovery query prior to throwing a remote exception which terminates the remote method call.

2. The method of claim 1, wherein the connection is an HTTP connection.

3. The method of claim 1, wherein the remote method call parameters include an object id, method id, and method arguments of the server side remote method call object.

4. The method of claim 3, wherein writing includes serializing the method arguments.

5. The method of claim 1, wherein responsive to an affirmative recovery response of the at least one recovery query, the remote method call error process restarts the remote method call over at the step of executing the instruction at the mobile device to open a connection at the Host URL.

6. The method of claim 1, wherein the remote exception is a lightweight object request broker (IORB) remote exception.

7. The method of claim 1, wherein responsive to non-detection of errors, said method further comprising:
querying at least one selected from the group consisting of a connection status query, an input stream status query, and an input stream read version validity query, wherein responsive to a negative or invalid status of a corresponding query, executing the remote method call error recovery process for performing a restart of the remote method call in response to the at least one recovery query prior to throwing the remote exception which terminates the remote method call.

8. The method of claim 1, wherein the remote method call error recovery process includes recovery queries, the recovery queries including at least one selected from the group consisting of a task abort query, a retry enabled query, and a retry limit query.

9. The method of claim 8, wherein responsive to a result of the task abort query being abort, the remote method call error recovery process throws the remote exception, thereby terminating the remote method call.

10. The method of claim 8, wherein responsive to a result of the task abort query being not to abort, the remote method call error recovery process further including the retry enabled query.

11. The method of claim 8, wherein responsive to a result of the retry enabled query being non-enabled, the remote method call error recovery process throws the remote exception, thereby terminating the remote method call.

12. The method of claim 8, wherein responsive to a result of the retry enabled query being enabled, the remote method call error recovery process further includes incrementing a retry count in response to the retry being enabled.

13. The method of claim 12, further wherein the retry limit query occurs subsequent to the retry enabled query and the incrementing of the retry count, wherein responsive to the retry count not exceeding a maximum number of retry attempts, the remote method call error recovery process further including executing a sleep mode prior to restarting the remote method call.

14. The method of claim 13, wherein the sleep mode includes a pause on the order of 1000 ms.

15. The method of claim 13, still further wherein responsive to the retry count exceeding the maximum number of retry attempts, the remote method call error recovery process throws the remote exception, thereby terminating the remote method call.

16. The method of claim 8, wherein the remote method call error recovery process further includes executing a sleep mode prior to restarting the remote method call.

17. A Java-enabled mobile apparatus for use in a wireless mobile messaging system, the mobile device configured to perform a method of implementing a client side remote method call, wherein the method comprising:
executing an instruction at the mobile device to open a connection at a Host URL, the Host URL including a server side object of the remote method call;
opening an output stream via the connection;
writing remote method call parameters to the server side remote method call object at the Host URL via the output stream;
opening an input stream via the connection for receiving return data from the Host URL; and
querying the return data for any occurrence of errors in the remote method call request in response the server side remote method call object and the remote method call parameters, wherein responsive to a detection of errors, executing a remote method call error recovery process for performing a restart of the remote method call in response to at least one recovery query prior to throwing a remote exception which terminates the remote method call.

18. The apparatus of claim 17, wherein the connection is an HTTP connection.

19. The apparatus of claim 17, wherein the remote method call parameters include an object id, method id, and method arguments of the server side remote method call object.

20. The apparatus of claim 19, wherein writing includes serializing the method arguments.

21. The apparatus of claim 17, wherein responsive to an affirmative recovery response of the at least one recovery query, the remote method call error process restarts the remote method call over at the step of executing the instruction at the mobile device to open a connection at the Host URL.

22. The apparatus of claim 17, wherein the remote exception is a lightweight object request broker (IORB) remote exception.

23. The apparatus of claim 17, wherein the method further comprising in response to non-detection of errors, querying at least one selected from the group consisting of a connection status query, an input stream status query, and an input stream read version validity query, wherein responsive to a negative or invalid status of a corresponding query, executing the remote method call error recovery process for performing a restart of the remote method call in response to the at least one recovery query prior to throwing the remote exception which terminates the remote method call.

24. The apparatus of claim 17, wherein the remote method call error recovery process includes recovery queries, the recovery queries including at least one selected from the group consisting of a task abort query, a retry enabled query, and a retry limit query.

25. The apparatus of claim 24, wherein responsive to a result of the task abort query being abort, the remote method call error recovery process throws the remote exception, thereby terminating the remote method call.

26. The apparatus of claim 24, wherein responsive to a result of the task abort query being not to abort, the remote method call error recovery process further including the retry enabled query.

27. The apparatus of claim 24, wherein responsive to a result of the retry enabled query being non-enabled, the remote method call error recovery process throws the remote exception, thereby terminating the remote method call.

28. The apparatus of claim 24, wherein responsive to a result of the retry enabled query being enabled, the remote method call error recovery process further includes incrementing a retry count in response to the retry being enabled.

29. The apparatus of claim 28, further wherein the retry limit query occurs subsequent to the retry enabled query and the incrementing of the retry count, wherein responsive to the retry count not exceeding a maximum number of retry attempts, the remote method call error recovery process further including executing a sleep mode prior to restarting the remote method call.

30. The apparatus of claim 29, still further wherein responsive to the retry count exceeding the maximum number of retry attempts, the remote method call error recovery process throws the remote exception, thereby terminating the remote method call.

31. The apparatus of claim 24, wherein the remote method call error recovery process further includes executing a sleep mode prior to restarting the remote method call.

32. A computer program stored on a computer readable medium for implementing a client side remote method call from a Java-enabled device, the computer program processable by a processor of the Java-enabled device for causing the processor to:
execute an instruction at the mobile device to open a connection at a Host URL, the Host URL including a server side object of the remote method call;
open an output stream via the connection;
write remote method call parameters to the server side remote method call object at the Host URL via the output stream;
open an input stream via the connection for receiving return data from the Host URL; and
query the return data for any occurrence of errors in the remote method call request in response the server side remote method call object and the remote method call parameters, wherein responsive to a detection of errors, execute a remote method call error recovery process for performing a restart of the remote method call in response to at least one recovery query prior to throwing a remote exception which terminates the remote method call.

33. The computer program of claim 32, wherein the connection is an HTTP connection.

34. The computer program of claim 32, wherein the remote method call parameters include an object id, method id, and method arguments of the server side remote method call object.

35. The computer program of claim 34, wherein writing includes serializing the method arguments.

36. The computer program of claim 32, wherein responsive to an affirmative recovery response of the at least one recovery query, the remote method call error process restarts the remote method call over at the step of executing the instruction at the mobile device to open a connection at the Host URL.

37. The computer program of claim 32, wherein the remote exception is a lightweight object request broker (IORB) remote exception.

38. The computer program of claim 32, wherein responsive to non-detection of errors, said computer program further for causing the processor to:
perform at least one query selected from the group consisting of a connection status query, an input stream status query, and an input stream read version validity query, wherein responsive to a negative or invalid status of a corresponding query, executing the remote method call error recovery process for performing a restart of the remote method call in response to the at least one recovery query prior to throwing the remote exception which terminates the remote method call.

39. The computer program of claim 32, wherein the remote method call error recovery process includes recovery queries, the recovery queries including at least one selected from the group consisting of a task abort query, a retry enabled query, and a retry limit query.

40. The computer program of claim 39, wherein responsive to a result of the task abort query being abort, the remote method call error recovery process throws the remote exception, thereby terminating the remote method call, and wherein responsive to a result of the task abort query being not to abort, the remote method call error recovery process further including the retry enabled query.

41. The computer program of claim 39, wherein responsive to a result of the retry enabled query being non-enabled, the remote method call error recovery process throws the remote exception, thereby terminating the remote method call, and wherein responsive to a result of the retry enabled query being enabled, the remote method call error recovery process further includes incrementing a retry count in response to the retry being enabled.

42. The computer program of claim 41, further wherein the retry limit query occurs subsequent to the retry enabled query and the incrementing of the retry count, wherein responsive to the retry count not exceeding a maximum number of retry attempts, the remote method call error recovery process further including executing a sleep mode prior to restarting the remote method call, and still further wherein responsive to the retry count exceeding the maximum number of retry attempts, the remote method call error recovery process throws the remote exception, thereby terminating the remote method call.

43. The computer program of claim 39, wherein the remote method call error recovery process further includes executing a sleep mode prior to restarting the remote method call.
